(19) United States
(12) Patent Application Publication
(10) Pub. No.: US 2026/0312306 A1
(43) Pub. Date: Oct. 8, 2026

(54) IMPROVED CABLE CONNECTING PIECE

(71) Applicant: Safetrack Infrasystems SISAB AB, STAFFANSTORP (SE)

(72) Inventor: Bo Svensson, VEBERÖD (SE)

(21) Appl. No.: 19/481,823

(22) PCT Filed: Apr. 12, 2024
(86) PCT No.: PCT/EP2024/059992

§ 371 Date: Nov. 5, 2025

(30) Foreign Application Priority Data
May 9, 2023 (SE) 2350568-8

(51) Int. Cl. H01R 4/64; B23K 1/00; B23K 1/005; B23K 20/10; B23K 35/02; B23K 35/30; B23K 101/36; E01B 29/42; H01R 4/62; H01R 43/02

(52) U.S. Cl. CPC H01R 4/64; B23K 1/0016; B23K 1/005; B23K 20/10; B23K 35/0233; B23K 35/3006; E01B 29/42; H01R 4/625; H01R 43/0207; B23K 2101/36

(57) ABSTRACT

There is provided a brazing-prepared cable connecting piece of electrically conductive material for attachment of a cable to a workpiece, the brazing-prepared cable connecting piece comprising: a plate portion comprising a first surface for attachment to the workpiece; a cable receiving portion for receiving a cable; and a sheet of 5 brazing material provided on the first surface of the plate portion, wherein the sheet of brazing material is attached to the first surface by an ultrasonic weld.

### TECHNICAL FIELD

The present invention relates to a cable connecting piece of electrically conducting material, and more particularly to a cable connecting piece for attachment to a workpiece by a brazing process, and a method of producing the same.

### BACKGROUND

The trend in rail-bound traffic is vehicles moving at higher speeds and with heavier axle loads. This places greater demands on the strength of the rails and the abrasion resistance. The rails are therefore made of high alloy steels to meet the stricter requirements. The high alloy steel material used in rails is sensitive to heat stress that can cause structural changes known as martensite formation (or curing effect). Martensite formation can cause cracking in rail material and, due to the higher loads, rail failure can result in catastrophic consequences for rail-bound traffic.

It is often necessary to attach cables or wires (e.g. signal wires) to the rails. A common method of attaching cables or wires is by use of connecting pieces such as cable shoes. Cable shoes are preferably used when a permanent connection between the cable and the rail is desired, but a direct connection is difficult, or impossible, to achieve.

These cables or wires need to be robustly and safely attached to the rails so as to reduce the risk of coming loose, the rails cracking, and/or any other rail failure.

Thus, it is very important that cables or wires are attached to the rails in a manner that does not cause martensite formation.

A known temperature-controlled brazing process may be used to reduce the risk of martensite formation. The brazing process requires the cable shoe to be provided with a brazing material. However, known methods of providing cable shoes with brazing material are complicated and difficult to use.

From the above, it is understood that there is room for improvements and the invention aims to solve or at least mitigate the above and other problems.

### SUMMARY

The invention is defined by the appended independent claims. Additional features and advantages of the concepts disclosed herein are set forth in the description which follows, and in part will be clear from the description, or may be learned by practice of the described technologies. The features and advantages of the concepts may be realized and obtained by means of the instruments and combinations particularly pointed out in the appended claims. These and other features of the described technologies will become more fully apparent from the following description and appended claims, or may be learned by the practice of the disclosed concepts as set forth herein.

According to a first aspect, there is provided a brazing-prepared cable connecting piece of electrically conductive material for attachment of a cable to a workpiece, the brazing-prepared cable connecting piece comprising: a plate portion comprising a first surface for attachment to the workpiece; a cable receiving portion for receiving a cable; and a sheet of brazing material provided on the first surface of the plate portion, wherein the sheet of brazing material is attached to the first surface by an ultrasonic weld.

Preferably, the brazing material comprises silver.

Preferably, the sheet of brazing material is in direct contact with the first surface of the plate portion.

Preferably, the ultrasonic weld comprises a plurality of ultrasonic spot welds forming a first knurl pattern on the sheet of brazing material.

Preferably, the first surface comprises a second knurl pattern.

Preferably, a second surface of the plate portion opposite to the first surface comprises a third knurl pattern.

According to a second aspect, there is provided a method of manufacturing a brazing-prepared cable connecting piece, the method comprising: providing a cable connecting piece comprising a plate portion and a cable receiving portion; providing a sheet of brazing material; placing the sheet of brazing material on a first surface of the plate portion; and ultrasonically welding, by an ultrasonic welding apparatus, the sheet of brazing material to the first surface so as to attach the sheet of brazing material to the first surface.

Preferably, the brazing material comprises silver.

Preferably, the step of ultrasonically welding comprises performing a plurality of ultrasonic spot welds.

Preferably, the method further comprises a step of imprinting the sheet of brazing material with a first knurl pattern by the plurality of ultrasonic spot welds.

Preferably, the method further comprises a step of imprinting the first surface with a second knurl pattern by the plurality of ultrasonic spot welds.

Preferably, the step of ultrasonically welding comprises applying, by the ultrasonic welding apparatus, a holding force to the cable connecting piece, and imprinting, by the holding force, a second surface of the plate portion opposite to the first surface with a third knurl pattern.

Preferably, the ultrasonic welding and the imprinting of the second surface are performed in a single pressing motion.

According to a third aspect, there is provided a method of brazing a cable shoe to a workpiece, the method comprising: manufacturing a brazing-prepared cable connecting piece according to method of the second aspect; placing the brazing-prepared cable connecting piece against the workpiece such that the sheet of brazing material of the brazing-prepared cable connecting piece is in contact with the workpiece; pressing an electrode of a brazing gun against the brazing-prepared cable connecting piece; allowing a current to flow from a power source of the brazing gun to the brazing-prepared cable connecting piece via the electrode; igniting an electric arc by forming an air gap between the electrode and the brazing-prepared cable connecting piece; and forming a bond between the brazing-prepared cable connecting piece and the workpiece by melting the sheet of brazing material by heat transmitted through the cable connecting piece.

### BRIEF DESCRIPTION OF THE DRAWINGS

In order to best describe the manner in which the above-described embodiments are implemented, as well as define other advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings in which:

FIG. 1a shows a perspective view of a cable connecting piece;

FIG. 1b shows a side view of a cable connecting piece;

FIG. 1c shows a cross-section of a cable connecting piece;

FIG. 1d shows a front view of a cable connecting piece;

FIG. 1e shows a perspective view of a cable connecting piece;

FIG. 1f shows a perspective view of a cable connecting piece;

FIG. 2a shows a prior art brazing clip;

FIG. 2b shows a cable connecting piece with a brazing clip;

FIG. 2c shows a cross-section of a cable connecting piece with a brazing clip;

FIG. 2d shows a prior art brazing clip;

FIG. 2e shows a manufacturing step of a cable connecting piece with a brazing clip;

FIG. 2f shows a cable connecting piece with a brazing clip;

FIG. 3a shows a brazing gun attaching a cable connecting piece to a workpiece;

FIG. 3b shows schematically a brazing gun attaching a cable connecting piece to a workpiece;

FIG. 3c shows a detail view of a brazing gun attaching a cable connecting piece to a workpiece;

FIG. 4 shows a principle of a brazing gun;

FIG. 5 shows a method of using a brazing gun;

FIG. 6a shows a perspective view of a cable connecting piece according to embodiments;

FIG. 6b shows a side view of a cable connecting piece according to embodiments;

FIG. 6c shows a bottom view of a cable connecting piece according to embodiments;

FIG. 7 shows an apparatus for ultrasonic welding;

FIG. 8 shows a method of manufacturing a cable connecting piece according to embodiments; and

FIG. 9 shows a method of attaching a cable connecting piece to a workpiece according to embodiments.

Further, in the figures like reference characters designate like or corresponding elements or parts throughout the several figures. The first digit in the reference character denotes the first figure in which the corresponding element or part appears.

### DETAILED DESCRIPTION

Various embodiments of the disclosed methods and arrangements are discussed in detail below. While specific implementations are discussed, it should be understood that this is done for illustration purposes only. A person skilled in the relevant art will recognize that other components, configurations, and steps may be used without parting from the spirit and scope of the claimed invention.

Hereinafter, certain embodiments will be described more fully with reference to the accompanying drawings. It will be apparent to those skilled in the art that various modifications and variations can be made without departing from the inventive concept. Other embodiments will be apparent to those skilled in the art from consideration of the specification and practice disclosed herein. It is to be understood that elements and materials may be substituted for those illustrated and described herein, parts and processes may be reversed or omitted, certain features may be utilized independently, and embodiments or features of embodiments may be combined, all as would be apparent to the skilled person in the art.

The embodiments herein are provided by way of example so that this disclosure will be thorough and complete, and will fully convey the scope of the inventive concept, and that the claims be construed as encompassing all modifications, equivalents and alternatives of the present inventive concept which are apparent to those skilled in the art to which the inventive concept pertains. If nothing else is stated, different embodiments may be combined with each other.

Embodiments relate to a cable connecting piece of electrically conductive material that is to be attached to a workpiece by means of a temperature-controlled brazing process. When the workpiece is made from a material comprising steel or a steel alloy, the temperature-controlled brazing process ensures that the brazing obtained is at least substantially martensite free, and preferably martensite free. That is, a brazing is obtained substantially without adverse structural changes (martensite formation) in the crystal structure of the workpiece. In other words, the temperature-controlled brazing process can be used to obtain a brazing that is completely or substantially free of martensite formation.

Martensite free brazing is particularly advantageous when, for example, attaching connecting pieces to railway tracks (e.g. to the rails of the railway track), pipelines, wind turbines, and nuclear power plant components.

For example, the temperature-controlled brazing process, and the cable connecting piece, may be used to attach:
one or more cables to the rails of railway tracks;
one or more anodes to a pipeline or ship (e.g. a tank ship) to prevent corrosion; and/or
one or more lightning rods or lightning connectors to, for example, wind turbines.

In particular, embodiments relate to a cable connecting piece that is prepared for attachment to a workpiece by the described temperature-controlled brazing process, and methods of manufacturing and/or producing the same.

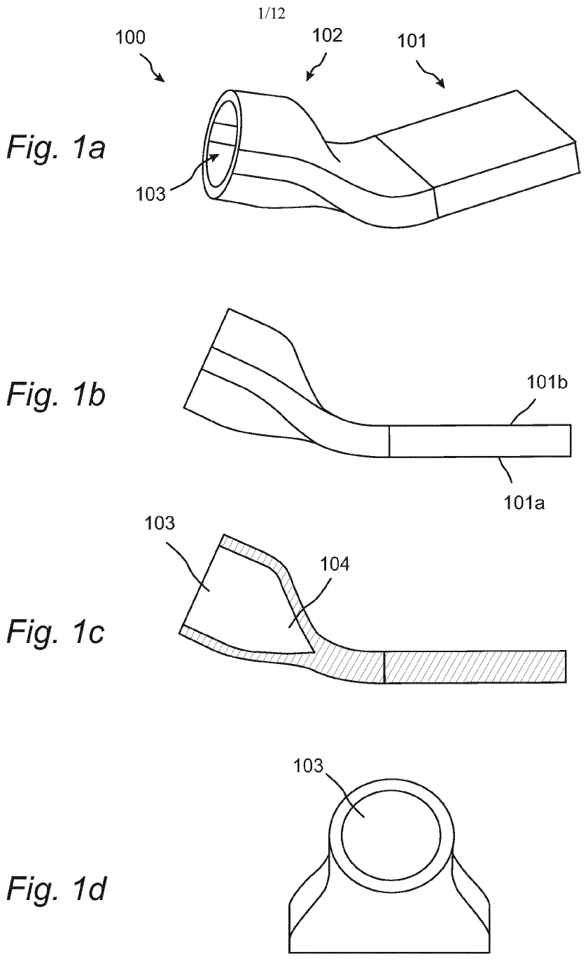

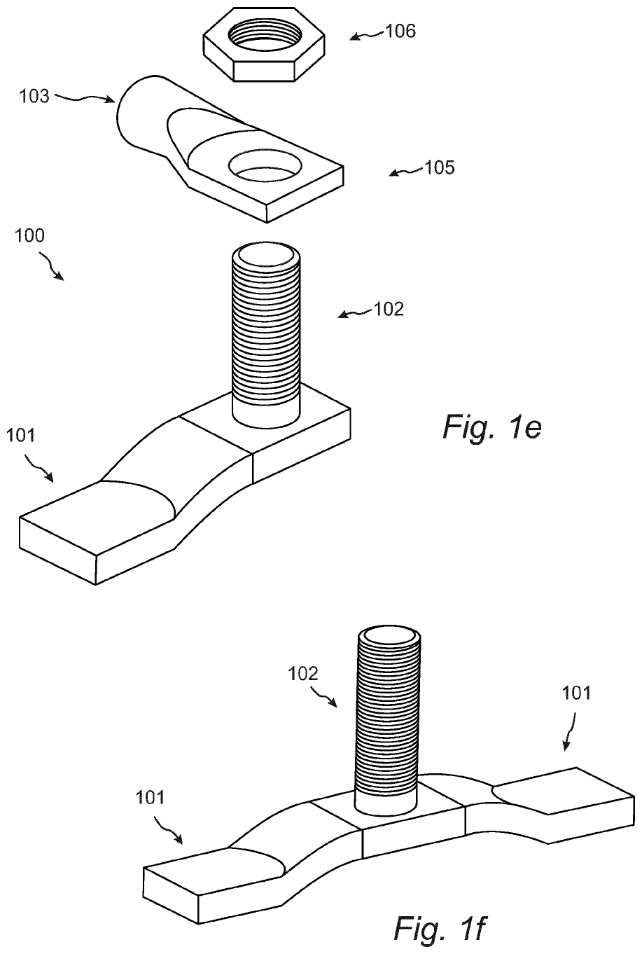

FIGS. 1a to 1f show a cable connecting piece 100 of electrically conductive material. The exemplary cable connecting piece 100 shown in FIGS. 1a to 1d is a cable shoe. The cable connecting piece 100 shown in FIG. 1e is a single-leg cable connector for use with a cable shoe. The cable connecting piece 100 shown in FIG. 1f is a two-legged cable connector for use with a cable shoe. The cable connecting piece 100 may also be a cable lug, a cable holder, a cable terminal, or the like.

The cable connecting piece 100 is a connector configured to connect a cable or wire to a workpiece (e.g. a rail of a railway track). A cable connecting piece 100 is preferably used when a permanent connection between the cable and the workpiece is desired, but a direct connection or attachment between the cable and the workpiece is difficult, or impossible, to achieve. Examples of cables or wires include but are not limited to signal cables, signal wires, lightning rods or lightning connectors, anodes for corrosion prevention, or any other cables or wires that are desirable to connect to a workpiece.

The cable connecting piece 100 is, at least partly, made from an electrically conductive material so as to allow an electrical signal to be transmitted from the cable or wire received by the cable connecting piece 100 to the workpiece. Preferably, the electrically conductive material comprises a metal. Even more preferably, the electrically conductive material comprises copper and/or a copper alloy. In embodiments, the cable connecting piece 100 may be made from copper and/or copper alloy.

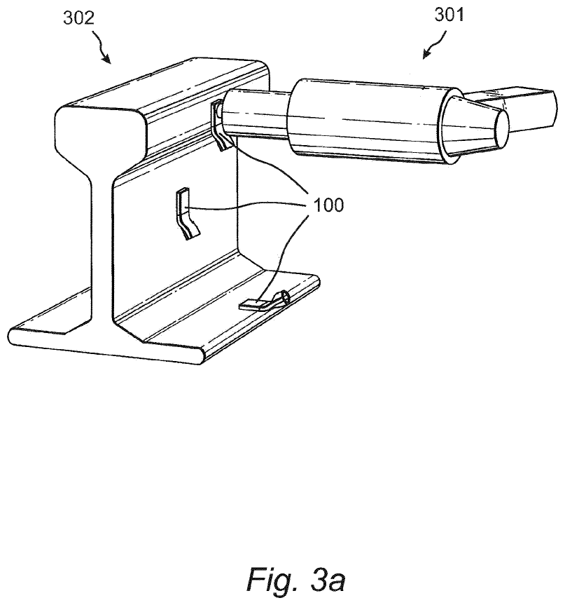

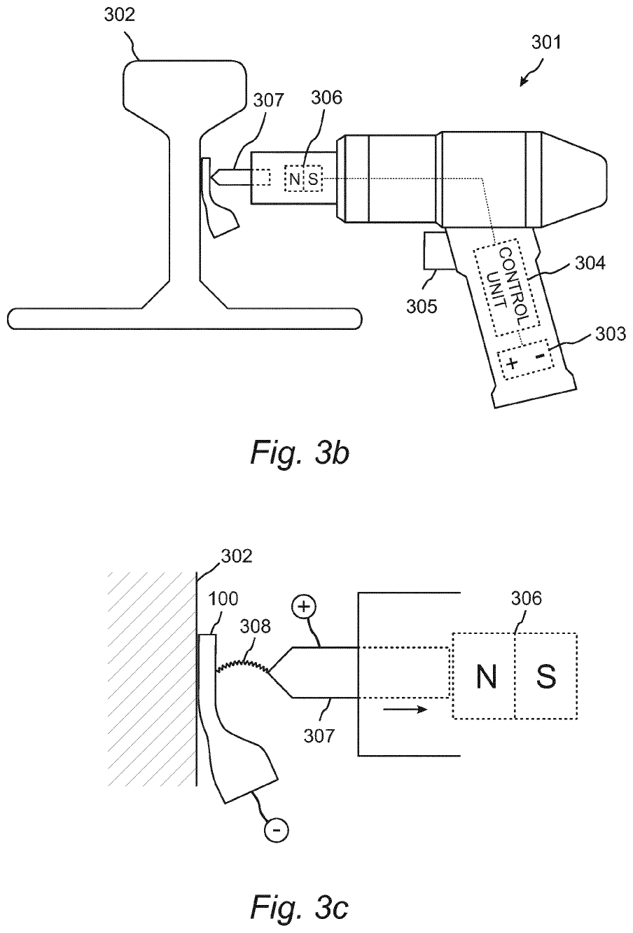

The cable connecting piece 100 according to embodiments is intended to be attached to the workpiece by a temperature-controlled brazing process. An exemplary temperature-controlled brazing process will be described in more detail in relation to FIGS. 3 to 5. It will be appreciated that the cable connecting piece 100 according to embodiments is not limited to use in the described temperature-controlled brazing process but may be used with any suitable brazing process for attachment to a workpiece.

The cable connecting piece 100 may comprise a plate portion 101 and a cable receiving portion 102. The plate portion 101 is a substantially flat plate. The plate portion 101 is configured to be attached to a workpiece. In particular, a first surface 101a of the plate portion 101 is configured to be brazed into contact with the workpiece, so as to attach the first surface 101a to the workpiece. The plate portion 101 may be substantially solid and/or compact. Alternatively, the plate portion 101 may comprise one or more through-holes (not shown) between the first surface 101a and a second surface 101b opposite to the first surface 101a.

The cable receiving portion 102 is configured to receive a cable or wire. The cable receiving portion 102 may receive the cable or wire directly or indirectly.

FIGS. 1a to 1d show a cable connecting piece 100 with a cable receiving portion 102 configured to receive the wire directly. This type of cable connecting piece 100 may be referred to as a cable shoe. The cable receiving portion 102 of the cable shoe comprises a cable cavity 103 for receiving a cable or wire. The shape and/or size of the cable cavity 103 may be determined in dependence on the shape and/or size of the cable or wire to be received. The cable receiving portion 102 may further be designed such that the cable cavity 103 extends into a tapering cavity 104. The tapering cavity 104 has a tapered cross-section. When a cable is received by the cable cavity 103, the tapering of the tapering cavity 104 ensures that the tapering cavity 104 is at least partly unoccupied by the cable. The tapering cavity 104 can thus reduce an amount of heat transmitted through the cable shoe to the cable when the cable shoe is attached to the workpiece by a brazing process. Accordingly, the tapering cavity 104 reduces the amount of power needed to perform the brazing process.

In embodiments, the cable shoe may be formed by pressing a pipe or tube such that one portion of the pipe or tube is pressed flat (thus forming the plate portion 101), and another portion remains substantially circular so as to form the cable cavity 103 for receiving the cable or wire. Said pressing of a pipe or tube also advantageously ensures that a tapering cavity 104 is formed between the plate portion 101 and the cable cavity 103.

FIGS. 1e and 1f, on the other hand, show a cable connecting piece 100 with a cable receiving portion 102 configured to receive the wire indirectly. This type of cable connecting piece 100 may be referred to as a cable connector. The cable connector may be used together with an intermediate connection member 105 (such as a cable shoe or cable lug) which provides the connection with the cable or wire.

The cable connector comprises at least one leg and a cable receiving portion 102. The at least one leg comprises the plate portion 101 for attachment to the workpiece. The plate portion 101 of the cable connector is substantially similar or identical to the previously described plate portion 101.

The cable connector may comprise a plurality of legs. For example, the cable connector may comprise 2 legs, 3 legs, or more legs. A larger number of legs ensures a larger contact area with the workpiece. Thus, a cable connector with a plurality of legs allows the cable connector to be used with larger cables (i.e. cables with larger cross-section).

The cable receiving portion 102 of the cable connector is configured to indirectly receive the cable or wire. For example, the cable receiving portion 102 may be configured to receive an intermediate connection member 105. The cable receiving portion 102 may comprise a connection means for connection with the intermediate connection member 105. The connection means may comprise a threaded member onto which the intermediate connection member 105 may be attached. The intermediate connection member may be locked in place on the connection means by a locking member 106, e.g. a nut or the like.

The intermediate connection member 105 may comprise a cable cavity 103 for receiving the cable or wire. Thus, when mounting the intermediate connection member 105 to the cable receiving portion 102 (via the connection means), there is provided a contact between the cable and the cable connector.

To attach a cable connecting piece 100, such as those shown in FIGS. 1a to 1f, to a workpiece by brazing, a brazing material (e.g. a metal such as silver) is commonly provided between the cable connecting piece 100 and the workpiece.

The brazing material has a lower melting point than the cable connecting piece 100, such that the brazing material can be melted without any melting of the cable connecting piece 100. Thus, the integrity of the cable connecting piece 100 can be maintained in the brazing process. The brazing material can thus be melted during the brazing process so as to, after the brazing process, form a firm bond between the cable connecting piece 100 and the workpiece. The bond has a high strength, allowing a robust attachment of the cable connecting piece 100 to the workpiece.

The bond also ensures good thermal and electrical conductivity between the cable connecting piece 100 and the workpiece.

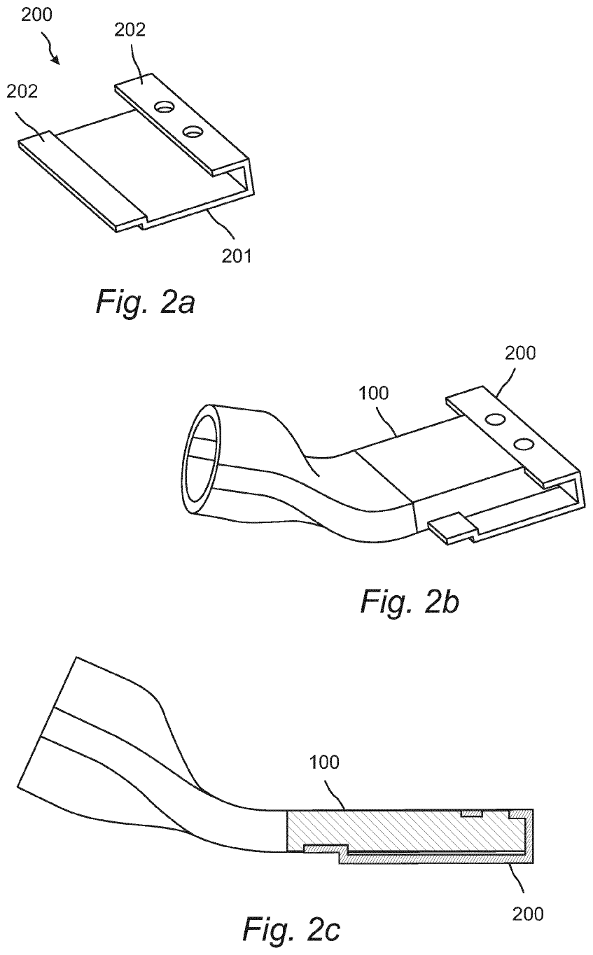

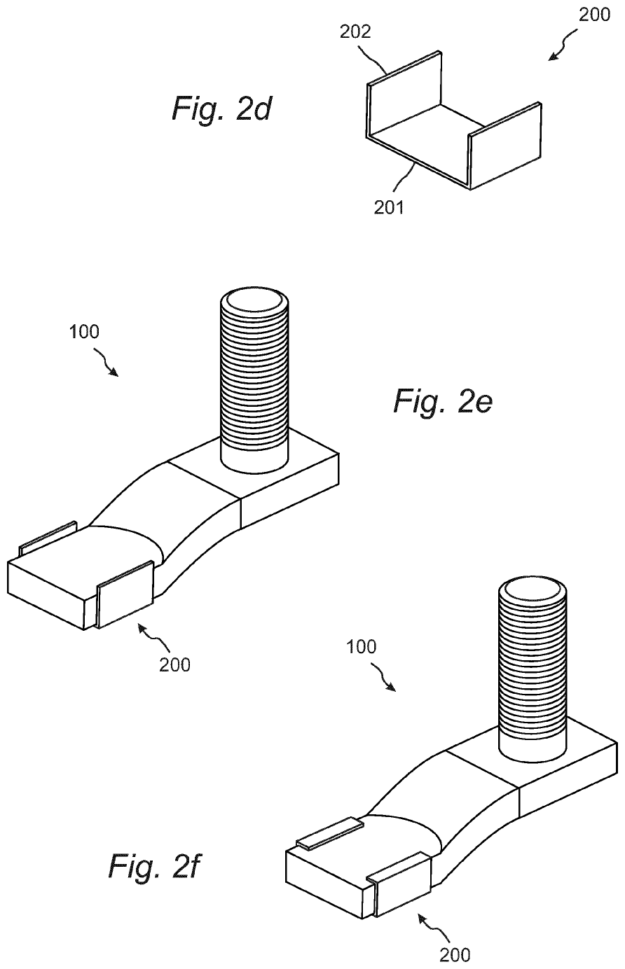

FIGS. 2a to 2c show a known brazing clip 200 as described in patent application SE0101688-0. FIG. 2d to 2f show a different known brazing clip, as described in patent application EP04732538.6, that is pressed onto a cable connecting piece 100. The brazing clips 200 shown in FIGS. 2a to 2f have been used with cable connecting pieces 100, such as those shown in FIGS. 1a to 1f.

The brazing clip 200 is made from brazing material and pressed into place on the cable connecting piece 100. The brazing clip 200 thus ensures that the brazing material is kept in position between the cable connecting piece 100 and the workpiece during the brazing process. The brazing clip 200 comprises a flat portion 201 arranged against the first surface 101a of the plate portion 101 of the cable shoe 100, and one or more flanges 202 that are bent and pressed over the plate portion 101 of the cable connecting piece.

The brazing clip 200 is arranged around the plate portion 101 of the cable shoe 100 and is pressed onto the plate portion 101. The brazing clip 200 is thus secured in position by the one or more flanges 202.

As the brazing material in the brazing clip 200 has to be bent and pressed onto the cable connecting piece 100 so as to form the flanges 202 (e.g. as shown in FIGS. 2d to 2f), the brazing material has to undergo an annealing process before the brazing clip 200 is attached to the cable connecting piece 100. In other words, the brazing material has to be heat treated such that it is softened and made more ductile so as to allow it to be bent. For example, when using silver as a brazing material, the brazing material needs to be annealed before the brazing clip 200 can be pressed onto the cable connecting piece 100. The inventors have realized that the annealing process sometimes leads to oxidation or other undesirable chemical reactions on the surface of the brazing material. The brazing clip 200 shown in FIGS. 2a to 2c has been designed so that it is larger than the plate portion 101 of the cable connecting piece 100 and protrudes next to it, see FIG. 2b. This reduces the amount of moisture that can penetrate between the cable connecting piece 100 and the workpiece by capillary force and thus reduces the risk of corrosion. Penetrating moisture can also adversely affect the mechanical strength of the braze joint. The brazing clip 200 being larger than the cable connecting piece 100 also gives a larger joint surface, resulting in a lower electrical resistance between the workpiece and the cable connecting piece 100.

When brazing the cable connecting piece 100 to a workpiece, flux material may be provided between the brazing clip 200 and the workpiece when the connecting piece 100 is brazed to the workpiece. The flux material can then be activated during the brazing process. The flux material ensures that the surfaces to be joined of both the brazing clip 200 and the workpiece are cleaned and wetted prior to the brazing process. The flux material also prevents oxidation occurring on said surfaces. The flux material should have good thermal conductivity, so as to facilitate heat transfer during the brazing process. Furthermore, the flux material should be suppressed by the molten brazing material during the brazing process.

FIGS. 3a to 3c show the use of a brazing gun 301 to attach a cable connecting piece 100 to a workpiece 302.

FIG. 3a shows a cable connecting piece 100 being attached to a workpiece 302 (in the form of a rail) using a brazing gun 301 configured to perform a temperature-controlled brazing process. The cable connecting piece 100 is brazed firmly to the head of the rail. The brazing may also be carried out on the web part or on the foot of the rail.

FIG. 3b shows a brazing gun 301 for use in a temperature-controlled brazing process. The brazing gun 301 comprises a power source 303, a control unit 304, a switch 305, a lifting magnet 306, and an electrode 307.

The power source 303 may be an internal power source such as a battery, or an external power source connected via a power supply interface such as a power supply cable. The power source 303 is configured to power the brazing process, under control of the control unit 304.

The control unit 304 is configured to regulate the current and voltage supplied in the brazing process. For example, the control unit 304 may regulate or control the power consumption and/or the activation time during the brazing process. The control unit 304 can thus ensure that a satisfactory brazing is achieved. The control unit 304 can also ensure that the brazing process is performed with reduced or minimal energy consumption.

The switch 305 may be a button or lever on the brazing gun 301 which the user may press or actuate so as to start and/or end the brazing process. For example, pressing the switch 305 may close an electrical circuit of the brazing gun 301.

The lifting magnet 306 is an electromagnet that can be activated by the control unit 304 and/or the switch 305. The lifting magnet 306 is capable of lifting (i.e. moving) the electrode 307.

The electrode 307 is preferably a carbon electrode. The electrode 307 may be arranged in an electrode holder that allows for interaction with the lifting magnet 306. For example, the electrode holder may be made of a magnetic material.

The brazing gun 301 may comprise an electrical circuit connecting the power source 303, control unit 304, switch 305, and lifting magnet 306.

The brazing gun 301 is described in more detail in patent applications SE0101688-0 and EP21167588.9.

To start the brazing process, the user places the cable connecting piece 100 (provided with the brazing clip 200) against the workpiece 302, and presses the brazing gun 301 against the second surface 101b of the plate portion 101 of the cable connecting piece 100. Thus, at the start of the start of the brazing process, the electrode 307 is pressed against the cable connecting piece 100. This can be seen in FIG. 3b. Note that the electric circuit is completed by the workpiece acting as ground.

Following this, the user presses the switch 305 so as to close the electrical circuit, allowing current to flow from the power source 303 to the cable connecting piece 100. Because the electrode 307 is initially in contact with the cable connecting piece 100, the electrical circuit of the brazing gun is substantially short-circuited.

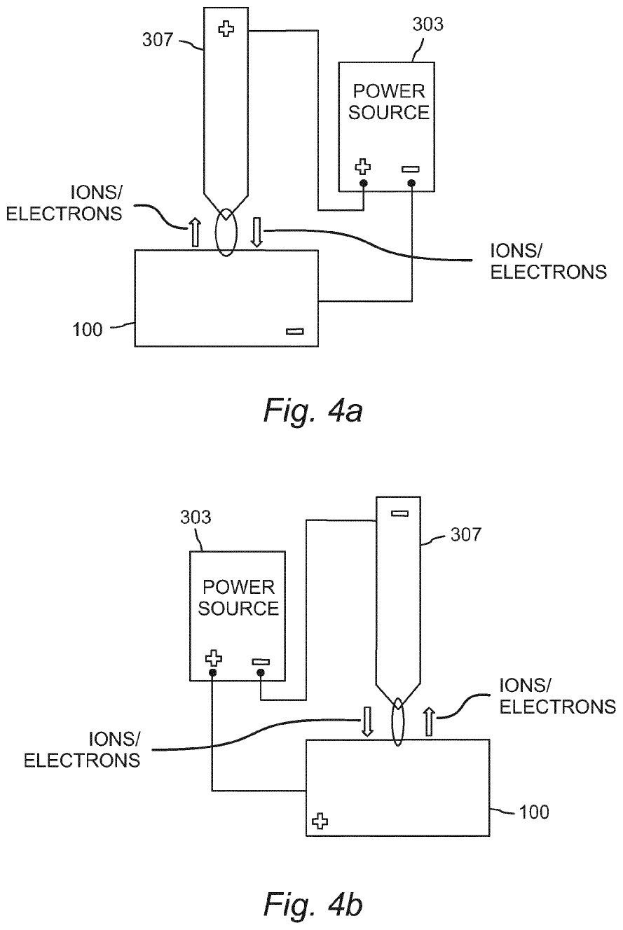

Subsequently, as seen in the detail view of FIG. 3c, the control unit 304 is configured to activate the lifting magnet 306 such that the lifting magnet 306 lifts the carbon electrode 307 from the cable connecting piece 100. This causes the electrode 307 to be separated from the cable connecting piece 100 by a certain height. The separation, and the difference in voltage potential across the air gap, will cause an electric arc 308 to be ignited. The electric arc 308 strikes the second surface 101b of the plate portion 101 of the cable connecting piece 100. Hence, the cable connecting piece 100 forms one pole (e.g. a negative pole) while the electrode 307 forms an opposite pole (e.g. a positive pole). It will be appreciated that the brazing process is not limited to the specific arrangement of polarities as shown in FIG. 3c, and that reverse polarities are also possible, as will be described in relation to FIG. 4.

The electric arc 308 heats up the cable connecting piece 100, and said heat is transmitted through the plate portion 101 of the cable connecting piece 100 to melt the brazing material in the brazing clip 200. A brazed joint is thus formed between the cable connecting piece 100 and the workpiece 302. Consequently, the cable connecting piece 100 is brazed firmly to the workpiece 302 without the electric arc 308 coming into direct contact with the workpiece 302.

In this temperature-controlled brazing process, the plate portion 101 of the cable connecting piece 100 will constitute a heat buffer against local overheating of the workpiece 302. The cable connecting piece 100 also provides a relatively uniform distribution of temperature over the entire melting surface. Hence martensite formation in the workpiece 302 can be prevented.

FIG. 4 shows the underlying principle of the brazing gun 301 during the brazing process. FIG. 4a shows a brazing process with the electrode 307 acting as a positive pole. FIG. 4b shows a reverse arrangement where the electrode 307 acts as a negative pole.

During the brazing process electrons and/or ions flow between the cable connecting piece 100 and the electrode 307. The direction of ions and/or electrodes will depend on the polarity of the electrode 307.

The oval area shown in FIG. 4, indicating the width of the arc, also shows that a thinner and more focused arc is achieved using a polarity corresponding to a negative electrode 307, while a wider or blurrier arc will result from connecting the electrode 307 to a positive polarity. To this effect, tests have shown that the choice of negative polarity of the electrode 307 reduces the energy needed to perform a brazing.

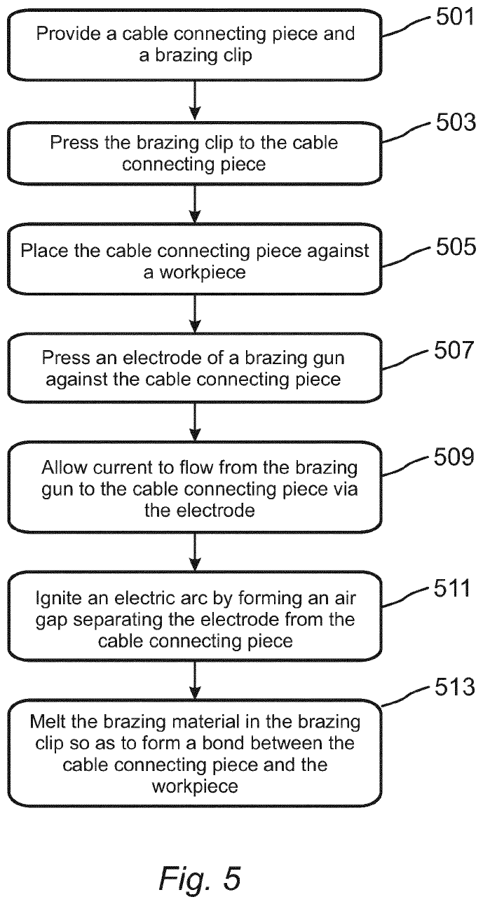

FIG. 5 shows a method of brazing using a brazing gun 301.

In step 501, a user provides a cable connecting piece 100 and a brazing clip 200.

In step 503, the user presses the brazing clip 200 to the cable connecting piece 100.

In step 505, the user places the cable connecting piece 100 against a workpiece. The workpiece may be a rail of a railway track. The cable connecting piece 100 is placed against the workpiece such that the flat portion 201 of the brazing clip 200 is in contact with the workpiece.

In step 507, the user presses an electrode 307 of a brazing gun 301 against the cable connecting piece 100. The electrode 307 is pressed against a side of the cable connecting piece 100 opposite to the side provided with the flat portion 201 of the brazing clip 200.

In step 509, a current is allowed to flow from a power source 303 of the brazing gun 301 to the cable connecting piece 100 via the electrode 307. For example, closing of a switch 305 may allow the current to flow.

In step 511, an electric arc 308 is ignited by forming an air gap separating the electrode 307 from the cable connecting piece 100. The difference in voltage potential across the air gap, maintained by the power source 303 and a control unit 304 of the brazing gun 301, causes the electric arc 308 to be ignited.

In step 513, the brazing material in the brazing clip 200 is melted by the heat transmitted through the cable connecting piece 100, so as to form a bond between the cable connecting piece 100 and the workpiece.

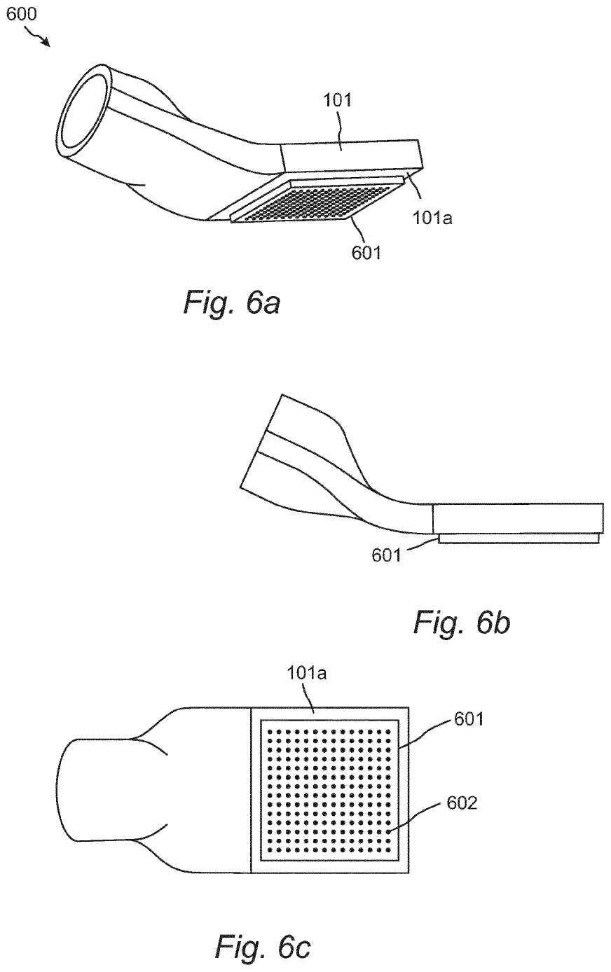

FIGS. 6a to 6c show a cable connecting piece 600 prepared for a brazing process according to embodiments. The cable connecting piece 600 may be referred to as a brazing-prepared cable connecting piece 600. The brazing-prepared cable connecting piece 600 is identical to the previously described cable connecting pieces 100 shown in FIG. 1, but the brazing-prepared cable connecting piece 600 further comprises a brazing sheet 601. The brazing sheet 601 that is attached to the cable connecting piece 600 by an ultrasonic weld.

In embodiments, the brazing sheet 601 may be attached directly to plate portion 101 of the brazing-prepared cable connecting piece 600. In other words, the brazing sheet 601 may be in direct contact with the surface 101a of the plate portion 101.

The brazing sheet 601 is made of a brazing material. The brazing material preferably comprises silver. Preferably, the brazing material comprises 30 to 80 wt % silver, 40 to 70 wt % silver, 50 to 60 wt % silver, 54 to 56 wt % silver. Even more preferably, the brazing material comprises 54 to 56 wt % silver (Ag), 20 to 22 wt % copper (Cu), 20 to 24 wt % zinc (Zn), and 1.5 to 2.5 wt % tin (Sn). For example, brazing material comprises about 55 wt % silver (Ag), about 21 wt % copper (Cu), about 22 wt % zinc (Zn), and about 2 wt % tin (Sn). For example, the brazing material may be a material satisfying the international standard for Ag 155 according to ISO 17672.

The brazing sheet 601 may be a substantially flat plate. The size of the brazing sheet 601 may be determined in dependence on the size of the brazing-prepared cable connecting piece 600, in particular on the size of the plate portion 101, and even more particularly on the size of second surface 101b of the plate portion 101. For example, the size of the brazing sheet 601 may be determined such that it covers a majority of the second surface 101b of the plate portion 101, or substantially the entire second surface 101b of the plate portion 101.

The shape of the brazing sheet 601 may be determined in dependence on the shape of the brazing-prepared cable connecting piece 600, in particular in dependence on the shape of the plate portion 101, and even more particularly in dependence on the shape of second surface 101b of the plate portion 101. For example, the shape of the brazing sheet 601 may be determined such that it covers a majority of the second surface 101b of the plate portion 101, or substantially the entire second surface 101b of the plate portion 101.

Because the brazing sheet 601 does not extend outside of the plate portion 101, and/or does not comprise flanges that bends over the plate portion 101, a significant amount of brazing material may be saved. Tests have shown that about 50% less brazing material may be used by the brazing-prepared cable connecting piece 600 according to embodiments compared to cable connecting pieces 100 provided with a brazing clip 200.

Furthermore, since the brazing sheet 601 is a flat sheet without any flanges that need to be bent over and/or pressed onto the plate portion 101, there is no need for the brazing material to undergo an annealing process before the brazing sheet is attached to the cable connecting piece. Thus, the manufacturing cost and complexity can be reduced.

The brazing sheet 601 may be thin. Preferably, the brazing sheet 601 has a thickness of between 0.1 to 1 mm, more preferably between 0.15 and 0.5 mm, even more preferably between 0.2 and 0.3 mm, and yet more preferably about 0.25 mm.

The ultrasonic weld ensures that the brazing sheet 601 is kept in place on the brazing-prepared cable connecting piece 600 during the brazing process. Further-more, the brazing-prepared cable connecting piece 600 with the brazing sheet 601 attached can be manufactured well in advance of the brazing process and stored for a long time.

The ultrasonic weld ensures that the brazing sheet 601 is firmly attached to the plate portion 101 of the brazing-prepared cable connecting piece 600. Furthermore, the ultrasonic weld ensures that the space or volume between the brazing sheet 601 and the plate portion 101 is reduced or removed, such that the adverse effect of air, moisture, and/or other contaminants on the surfaces between the brazing sheet 601 and the plate portion 101 can be reduced or removed. Thus, any oxidation behind the brazing sheet 601 can be significantly reduced (or eliminated), leading to a longer storage life of the brazing-prepared cable connecting pieces 600.

Furthermore, the inventors have realised that the vibration and friction forces occurring during the ultrasonic welding process removes oxides present on the surfaces between the brazing sheet 601 and the plate portion 101, as well as preventing new oxidation of said surfaces.

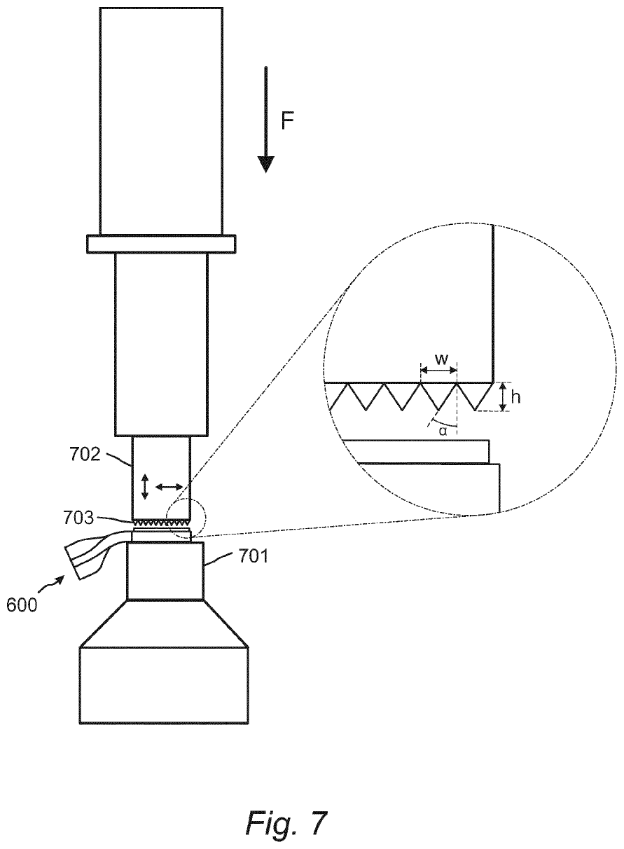

FIG. 7 shows an apparatus for ultrasonic welding that may be used to manufacture a brazing-prepared cable connecting pieces 600 according to embodiments. The apparatus comprises an anvil 701, a horn 702, and a transducer. A suitable ultrasonic welding apparatus is Branson GMX-20MA as manufactured by Emerson Electric Co.

The ultrasonic welding apparatus is configured to convert high-frequency electric energy into mechanical vibration energy through the transducer. This causes the horn 702 to vibrate at an ultrasonic frequency. The frequency may be between 20 and 60 kHz, preferably between 20 and 40 kHz, more preferably between 20 and 30 kHz, even more preferably between 20 and 25 kHz, and yet more preferably between 20 and 22 kHz. In an embodiment, the frequency is about 20 KHz.

The amplitude of the vibrations may be between 4 and 90 micrometers, preferably between 15 and 75 micrometers, and more preferably between 20 and 60 micrometers.

The apparatus may be configured to apply a holding force (F) so as to hold the brazing-prepared cable connecting piece 600 in place between the horn 702 and the anvil 701. The magnitude of the holding force is preferably between 800 and 4000 N, more preferably between 1000 and 3000 N, and even more preferably between 1500 and 2600 N.

The pressure acting on the brazing sheet 601 may be between 0.1 and 1 MPa (MPa=1 000 000 Pascal), preferably between 0.2 and 0.5 MPa, and even more preferably between 0.25 and 0.4 MPa.

The horn 702 may vibrate vertically (i.e. parallel to the direction of the holding force), horizontally (i.e. orthogonal to the direction of the holding force) or both vertically and horizontally.

When pressed down by the holding force, the horn 702 thus acts on brazing sheet 601, generating high-frequency friction between the brazing sheet 601 and the plate portion 101 until the surfaces of the brazing sheet 601 and the plate portion 101 are heated and welded together.

Importantly, the heat created (through friction) by the ultrasonic welding process is sufficient to weld the brazing sheet 601 to the plate portion 101 of the brazing-prepared cable connecting piece 600, but insufficient to completely melt the brazing sheet 601. In particular, a shape of the brazing sheet 601 may be substantially maintained in the ultrasonic welding process.

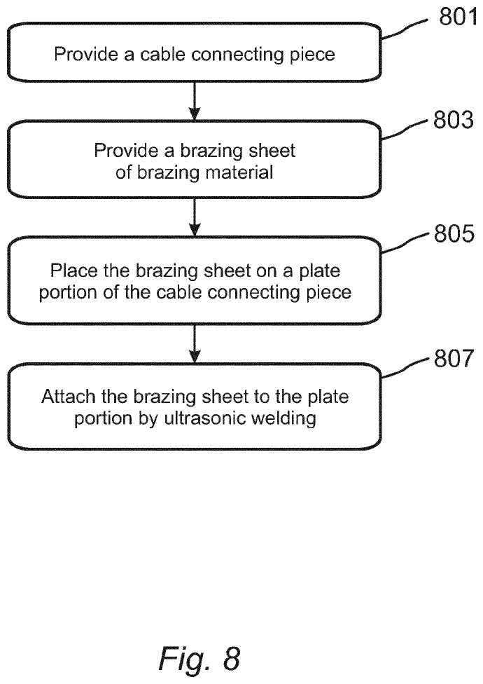

The horn 702 may, on a welding surface (e.g. the lower surface in FIG. 8), comprise one or more knurls 703 (e.g. teeth and/or cavities) for creating a respective one or more spot welds. Alternatively, the horn 702 may comprise one or more wedges for creating a respective one or more line welds. As yet another alternative, the horn 702 may comprise a flat or blank surface. The use of spot or line welds can significantly reduce the power or energy required to perform the ultrasonic welding process.

The knurls 703 may have any shape, including, but not limited to, pyramidal, conical, hemispherical, ellipsoidal, cylindrical, cubical, cuboidal, prism-shaped, polyhedron-shaped, and/or tetrahedron-shaped. The base of the knurls may be diamond-shaped, circular, oval, rectangular, quadratic, hexagonal, and/or polygonal. A cross-section of the knurls may be diamond-shaped, circular, oval, rectangular, quadratic, hexagonal, and/or polygonal.

The knurls 703 may be either female, e.g. cavities in the welding surface, or male, i.e. teeth protruding from the welding surface.

The knurls 703 may have a height h of between 0.3 and 0.7 mm. For example, the knurls 703 may have a height h of 0.65 mm. The knurls 703 may have a width w of between 0.6 and 1.4 mm. For example, the knurls 703 may have a width w of 1.3 mm. The knurls 703 may have an angle a (alpha) of between 30 to 60 degrees. For example, the knurls 703 may have an angle a (alpha) of 45 degrees.

For a horn 702 comprising a plurality of knurls 703, a knurl arrangement may be formed. The knurl arrangement may comprise knurls 703 arranged in rows and columns. The knurl arrangement may comprise one or more rows with a plurality of knurls 703 in each row. Additionally, or alternatively, the knurl arrangement may comprise one or more columns with a plurality of knurls 703 in each column. For example, the knurl arrangement may comprise knurls 703 arranged along a circumference (e.g. in a rectangle) of the horn 702.

A row may be perpendicular to a column. For example, the knurls 703 may be arranged in a grid pattern. Alternatively, the row may be angled compared to the column by any suitable angle, for example 30, 45, or 60 degrees. In other words, rows and/or columns may be shifted compared to adjacent rows and/or columns respectively. For example, the knurls 703 may be arranged in a grid pattern that is shifted or slanted or skew.

Knurls 703 in a row and/or column may be regularly spaced, or alternatively, the distance between knurls 703 may vary. For example, the rows and/or columns of the knurl arrangement may comprise 3 to 30 knurls per centimeter, more preferably 5 to 20 knurls per centimeter, and most preferably 7 to 15 knurls per centimeter.

As an alternative, the knurl arrangement may comprise knurls 703 arranged irregularly.

Due to the presence of a knurl arrangement on the horn 702, a knurl pattern 602 may be imprinted on the brazing sheet 601 when ultrasonically welded to the cable connecting piece 100. This is illustrated in in FIG. 6. Such a knurl pattern 602 imprinted on the brazing sheet 601 has been found to be advantageous for at least the following reasons.

The plurality of attachment (i.e. welded) points provided by a horn 702 with a knurl arrangement (and the corresponding knurl pattern 602 on the brazing sheet 601) increases the thermal and electrical conductivity between the plate portion 101 and the brazing sheet 601. which ensures a power efficient brazing process where the cable connecting piece is robustly attached to the workpiece without any martensite formation.

Another significant advantage, especially for brazing-prepared cable connecting pieces 600 intended for use on rails of a railway track or other vibrating workpieces, is that the strength of the brazing joint between the workpiece (e.g. rail) and the brazing-prepared cable connecting piece 600 is surprisingly improved by the knurl pattern 602. During the ultrasonic welding process, not only is the brazing sheet 601 imprinted with a knurl pattern 602 (by the knurl arrangement on the horn 702), but also the first surface 101a of the brazing-prepared cable connecting piece 600 underneath the brazing sheet 601. This is due to the brazing sheet 601 having a small thickness, and the force from the horn 702 therefore also impacting the first surface 101a. Thus, the first surface 101a may also comprise a knurl pattern 602, i.e. an undulated first surface 101a. The knurl pattern 602 on the first surface 101a may be similar or identical to the knurl pattern 602 on the brazing sheet 601, e.g. a distribution of knurls may be similar or identical. However, a depth of the knurl pattern 602 on the first surface 101a may be smaller than a depth of the knurl pattern 602 on the brazing sheet 601.

This undulated first surface 101a increases the effective surface area of the first surface 101a, which is to be brazed against the workpiece. Hence, the strength of the brazing joint is improved. As mentioned, this is particularly important for brazing-prepared cable connecting pieces 600 brazed onto a rail of a railway track because the rails undergo a significant amount of vibration every time a train passes by. It is similarly advantageous for other workpieces that undergo vibration.

Additionally, or alternatively, the anvil 701 may be provided with a knurl arrangement which may imprint a knurl pattern 602 on the second surface 101b of the cable connecting piece 100 during the ultrasonic welding process. The knurl arrangement of the anvil 701 may be similar or identical to the knurl arrangement on the horn 702. Alternatively, the knurl arrangement of the anvil 701 may be different to the knurl arrangement on the horn 702.

Thus, the holding force applied during the ultrasonic welding process may be utilized to also function as an imprinting force to imprint a knurl pattern 602 on the second surface 101b of the plate portion 101. In other words, a knurl pattern 602 may be imprinted on the second surface 101b in the same pressing motion as the brazing sheet 601 is welded to the brazing-prepared cable connecting piece 600.

The inventors have realized that this second knurl pattern is particularly advantageous for brazing-prepared cable connecting pieces 600 that are to be brazed to a workpiece using a brazing gun 301 in which the electrode 307 acts as a positive pole (i.e. as in FIG. 4a). When using such a brazing gun 301, the inventors have found that there is a problem in that carbon powder (i.e. ions) is released from the carbon electrode 307 during the brazing process. This carbon powder settles of the second surface 101b of the plate portion to form a flake-like structure. The flake-like structure may, when a sufficient amount of carbon powder has settled thereon, come loose from the surface (e.g. fall off the surface). In doing so, the flake-like structure is likely to interfere with the electric arc 308, occasionally extinguishing it by way of a short-circuit. The brazing process is thus prevented from being completed and has to be restarted. However, tests have found that a second surface 101b imprinted with a knurl pattern 602 (e.g. an undulated surface) according to embodiments reduces the risk of formation of such flake-like structures. The reliability of the brazing process can thus be improved. In embodiments, this knurl pattern on the second surface is imprinted simultaneously with the ultrasonic welding process, and thus no separate manufacturing step is required.

FIG. 8 shows a method of manufacturing a brazing-prepared cable connecting piece 600 according to embodiments. The method may also be referred to as a method of preparing a cable connecting piece for a brazing process.

In step 801, a cable connecting piece 600 is provided. The cable connecting piece 600 may be substantially the same as the cable connecting piece 100 described in relation to FIG. 1.

In step 803, a brazing sheet 601 is provided. The brazing sheet 601 comprises a brazing material.

In step 805, the brazing sheet 601 is placed on the first surface 101a of the plate portion 101 of the cable connecting piece 600.

In step 807, the brazing sheet 601 is attached to the cable connecting piece 600 by ultrasonic welding. The ultrasonic welding may be performed by the ultrasonic welding apparatus described in relation to FIG. 7.

The method may further comprise a step of imprinting the brazing sheet 601, and preferably also the first surface 101a of the plate portion 101 of the cable connecting piece 600, with a knurl pattern 602. Preferably, this step is performed simultaneously with step 807. For example, the holding force may be used to imprint the knurl pattern 602 on the brazing sheet 601 and/or the first surface 101a of the plate portion 101 of the cable connecting piece 600.

The method may, alternatively or additionally, further comprise a step of imprinting the second surface 101b of the plate portion 101 with a knurl pattern 602. Preferably, this step is performed simultaneously with step 807. For example, the holding force may be used to imprint the knurl pattern 602 on the second surface 101b of the plate portion 101.

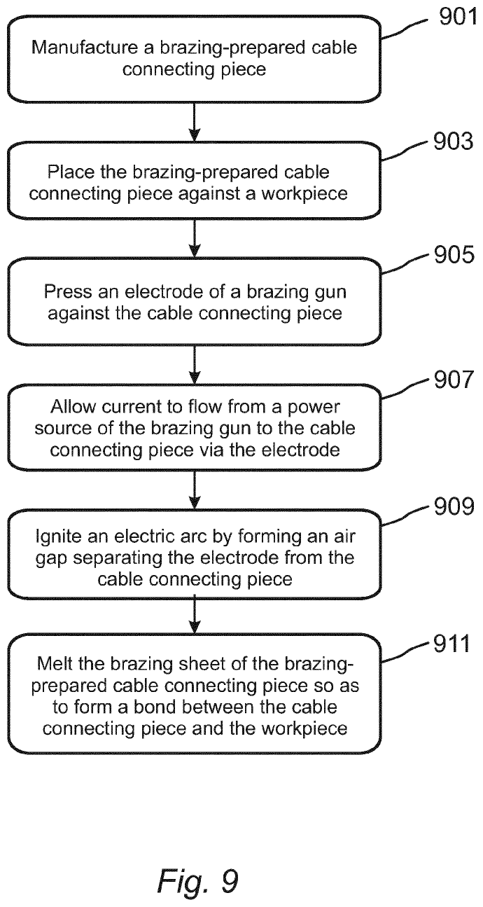

FIG. 9 shows a method of attaching a cable connecting piece to a workpiece according to embodiments.

In step 901, a brazing-prepared cable connecting piece 600 is manufactured according to the method of FIG. 8.

In step 903, the brazing-prepared cable connecting piece 600 is placed against a workpiece.

In step 905, an electrode 307 of a brazing gun 301 is pressed against the brazing-prepared cable connecting piece 600. The electrode 307 is pressed against a side of the brazing-prepared cable connecting piece 600 opposite to the side provided with the brazing sheet 601.

In step 907, a current is allowed to flow from a power source 303 of the brazing gun 301 to the brazing-prepared cable connecting piece 600 via the electrode 307. For example, the closing of a switch 305 may allow the current to flow.

In step 909, an electric arc 308 is ignited by forming an air gap separating the electrode 307 from the brazing-prepared cable connecting piece 600. The difference in voltage potential across the air gap, maintained by the power source 303 and a control unit 304 of the brazing gun 301, causes the electric arc 308 to be ignited.

In step 911, the brazing sheet 601 is melted by the heat transmitted through the plate portion 101, so as to form a bond between the brazing-prepared cable connecting piece 600 and the workpiece. Although the melting of the brazing sheet 601 will reverse the ultrasonic weld, the subsequent braze joint will create a firm bond between the brazing-prepared cable connecting piece 600 and the workpiece. It is noted that although re-brazing of a joint is generally ill-advised if a strong bond is desired, the inventor has realized that the brazing process according to FIG. 9 allows the ultrasonic weld to be completely melted such that it does not have any adverse effects on the strength of the subsequent brazing joint.

Although FIGS. 3 to 9 have shown cable connecting pieces in the form of cable shoes (as shown in FIGS. 1a to 1d), it will be appreciated that embodiments include any other cable connecting pieces, such as the cable connectors shown in FIGS. 1e to 1f.

Throughout this specification, the word “may” is used in a permissive sense (i.e. meaning having the potential to), rather than in the mandatory sense (i.e. meaning must).

Throughout this specification, the words “comprise”, “include”, and variations of the words, such as “comprising” and “comprises”, “including”, “includes”, do not exclude other elements or steps.

As used throughout this specification, the singular forms “a”, “an”, and “the”, include plural referents unless explicitly indicated otherwise. Thus, for example, reference to “an” element includes a combination of two or more elements, notwithstanding use of other terms and phrases for one or more elements, such as “one or more” or “at least one”.

The term “or” is, unless indicated otherwise, non-exclusive, i.e. encompassing both “and” and “or”. For example, the feature “A or B” includes feature “A”, feature “B” and feature “A and B”.

Unless otherwise indicated, statements that one value or action is “based on” and/or “in dependence on” another condition or value or action, encompass both instances in which the condition or value or action is the sole factor and instances where the condition or value or action is one factor among a plurality of factors.

Unless otherwise indicated, statements that “each” instance of some collection have some property should not be read to exclude cases where some otherwise identical or similar members of a larger collection do not have the property, i.e. each does not necessarily mean each and every.

1. A brazing-prepared cable connecting piece of electrically conductive material for attachment of a cable to a workpiece, the brazing-prepared cable connecting piece comprising:
a plate portion comprising a first surface for attachment to the workpiece;
a cable receiving portion for receiving a cable; and
a sheet of brazing material provided on the first surface of the plate portion,
wherein the sheet of brazing material is attached to the first surface by an ultrasonic weld.

2. The brazing-prepared cable connecting piece according to claim 1, wherein the brazing material comprises silver.

3. The brazing-prepared cable connecting piece according to claim 1 or 2, wherein the sheet of brazing material is in direct contact with the first surface of the plate portion.

4. The brazing-prepared cable connecting piece according to any preceding claim, wherein the ultrasonic weld comprises a plurality of ultrasonic spot welds forming a first knurl pattern on the sheet of brazing material.

5. The brazing-prepared cable connecting piece according to any preceding claim, wherein the first surface comprises a second knurl pattern.

6. The brazing-prepared cable connecting piece according to any preceding claim, wherein a second surface of the plate portion opposite to the first surface comprises a third knurl pattern.

7. A method of manufacturing a brazing-prepared cable connecting piece, the method comprising:
providing a cable connecting piece comprising a plate portion and a cable receiving portion;
providing a sheet of brazing material;
placing the sheet of brazing material on a first surface of the plate portion; and
ultrasonically welding, by an ultrasonic welding apparatus, the sheet of brazing material to the first surface so as to attach the sheet of brazing material to the first surface.

8. The method according to claim 7, wherein the brazing material comprises silver.

9. The method according to claim 7 or 8, wherein the step of ultrasonically welding comprises performing a plurality of ultrasonic spot welds.

10. The method according to claim 9, wherein the method further comprises a step of imprinting the sheet of brazing material with a first knurl pattern by the plurality of ultrasonic spot welds.

11. The method according to claim 9 or 10, wherein the method further comprises a step of imprinting the first surface with a second knurl pattern by the plurality of ultrasonic spot welds.

12. The method according to any of claims 7 to 11, wherein the step of ultrasonically welding comprises applying, by the ultrasonic welding apparatus, a holding force to the cable connecting piece, and imprinting, by the holding force, a second surface of the plate portion opposite to the first surface with a third knurl pattern.

13. The method according to claim 12, wherein the ultrasonic welding and the imprinting of the second surface are performed in a single pressing motion.

14. A method of brazing a cable shoe to a workpiece, the method comprising:
manufacturing a brazing-prepared cable connecting piece according to the method of any of claims 7 to 13;
placing the brazing-prepared cable connecting piece against the workpiece such that the sheet of brazing material of the brazing-prepared cable connecting piece is in contact with the workpiece;
pressing an electrode of a brazing gun against the brazing-prepared cable connecting piece;
allowing a current to flow from a power source of the brazing gun to the brazing-prepared cable connecting piece via the electrode;
igniting an electric arc by forming an air gap between the electrode and the brazing-prepared cable connecting piece; and
forming a bond between the brazing-prepared cable connecting piece and the workpiece by melting the sheet of brazing material by heat transmitted through the cable connecting piece.
